(19) United States
(12) Patent Application Publication
(10) Pub. No.: US 2004/0252106 A1
(43) Pub. Date: Dec. 16, 2004

(54) Wireless input device charged through an attachable receiver

(76) Inventor: Chao-Ming Koh, Hsinchu (TW)

Correspondence Address: BACON & THOMAS, PLLC, 625 SLATERS LANE, FOURTH FLOOR, ALEXANDRIA, VA, 22314

(21) Appl. No.: 10/457,557

(22) Filed: Jun. 10, 2003

(51) Int. Cl. G09G 5/08

(52) U.S. Cl. 345/163

(57) ABSTRACT

A wireless input device charged through an attachable receiver includes a wireless input device operated by users for controlling a computer, and includes a receiver which is connected to the computer to receive the data from the input device and transmitting the data to the computer . The input device has a cavity and the cavity has a recharged plug inside for being recharged. When the battery of the wireless input device run out, the receiver has a recharged socket for transporting power through the recharged plug to the wireless input device.

### BACKGROUND OF THE INVENTION

1. Field of the Invention

The present invention relates to a wireless signal input source of computer and, more specifically, to a wireless input device which can be charged by computer through a attachable receiver, and can be carried easily.

2. Description of the Related Art

Along with advance in technology and general used of computers, the input devices such as mouse have become a necessary input device of computer for moving cursor position on screen and making selections. Not only computers, we also make use of them in PDA and satellite navigation equipment.

Mouse is used and connected to computer with a cable combined with several wires to get power supply and send signal to computer. When moving mouse, the cable is always dragged or pushed that makes people uncomfortable to use and makes moving inconveniently. Wireless device is developed to overcome this problem.

Wireless mouse, as the name it is, should have its own battery power to support electrical circuit. The drawback is the risk of battery run out but without spear battery nearby when in used. One attempted to solve this problem is a battery charger combined with receiver, when docking mouse on charger, re-chargeable battery in mouse can be charged by computer power through connection. For example, U.S. Pat. No. 6,498,458 (“BATTERY CHARGER FOR CHARGING A WIRLESS SINGAL SOURCE AND ATTACHABLE RECEIVER”). Drawback is the size of battery charger 6 is large, which occupy place of desk or not convenient to carry with portable computer.

### SUMMARY OF THE INVENTION

For overcoming said defects described above, an object of the present invention is to provide a wireless input device in which the wireless input device can be charged by computer power through an attachable receiver connected in between.

Another object of the present invention is to provide a wireless input device in which the attachable receiver can be stowed into cavity of the input device.

These and other objects, features and advantages of the present invention will become more apparent from the following description and the appended claims, taken in connection with the accompanying drawings in which preferred embodiment of the present invention are shown by way of illustrative example.

### A BRIEF DESCRIPTION OF THE DRAWINGS

FIG. 1 is a structure drawing disclosed in U.S. Pat. No. 6,498,458

FIG. 2A is a structure drawing of the first embodiment of the present invention.

FIG. 2B is another structure drawing of the first embodiment of the present invention with a different receiver structure

FIG. 3 is a sketch drawing of the present invention with data transmitting.

FIG. 4 is a sketch drawing of the present invention being charged.

FIG. 5 is a bottom view of the present invention

FIG. 6 is a lateral view of the present invention

FIG. 7 is a back view of the present invention

FIG. 8 is a structure drawing of the second embodiment of the present invention.

FIG. 9 is a structure drawing of the third embodiment of the present invention.

FIG. 10 is a structure drawing of the forth embodiment of the present invention.

FIG. 11 is a circuit diagram of the present invention.

FIG. 12 is a circuit diagram of one-way current control circuit in the present invention.

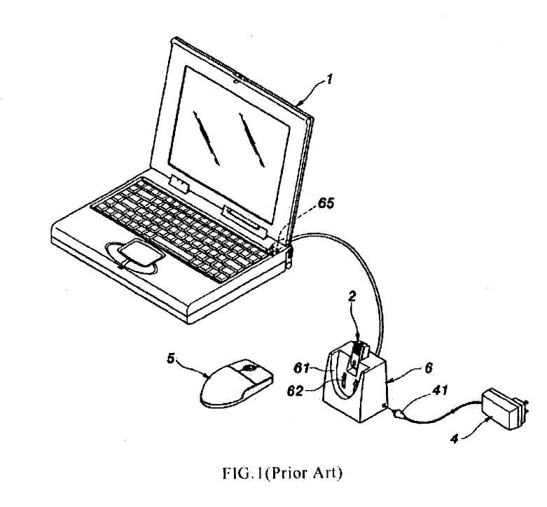

### DETAILED DESCRIPTION OF THE PREFERRED EMBODIMENT

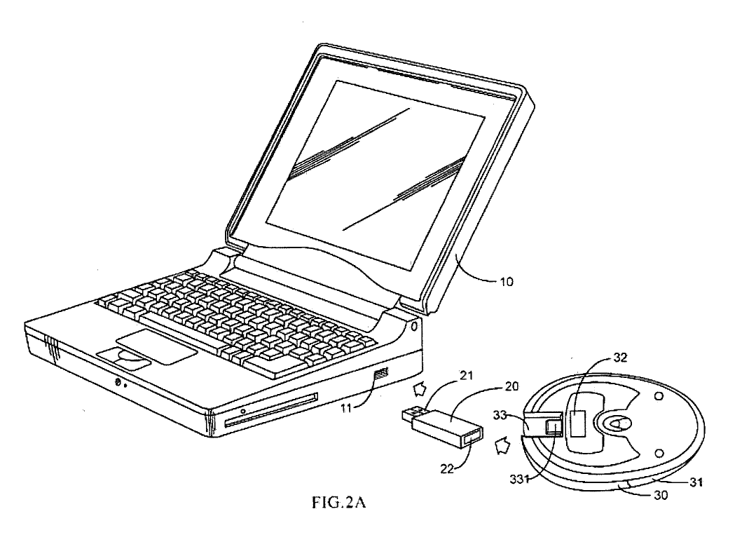

FIG. 2A is a structure drawing of the first embodiment of the present invention. It comprises a receiver 20, a connector 21, a recharged socket 22, a wireless input device 30, buttons 31, a movement detector 32, a receiver cavity 33, and a recharged plug 331.

FIG. 2B is another structure drawing of the first embodiment of the present invention with a different receiver structure. The recharged socket 22 and the recharged plug 331 can be exchanged.

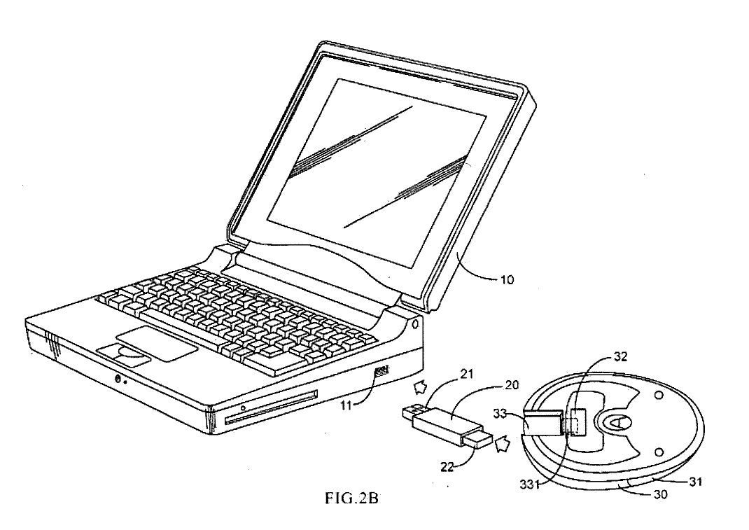

FIG. 3 is a sketch drawing of the present invention with data transmitting. When the connector 21 of the receiver 20 is connected to the connector socket 11 of the computer 10, user can control the computer 10 through the buttons 31 and the movement detector of the input device 30. The controlling signal produced by the input device 30 is transmitted to the computer by infra-ray or electromagnetic wave.

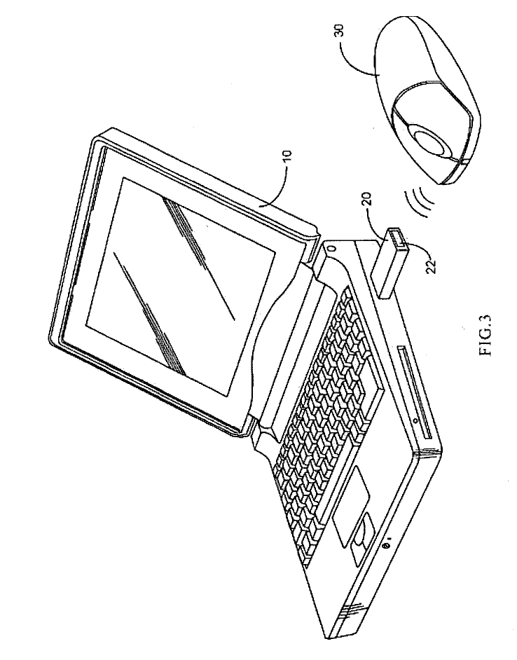

FIG. 4 is a sketch drawing of the present invention being charged. When the connector 21 is connected to the connector socket 11 of the computer 10 and the recharged socket 22 is connected to the recharged plug 331, the wireless input device 30 is being recharged until the power of the wireless input device 30 is full charged.

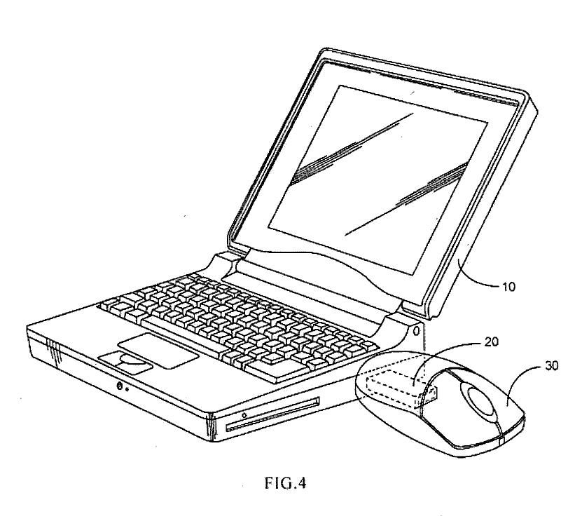

FIG. 5 is a bottom view of the present invention. It is a bottom view for the recharged socket 22 being plugged to the receiver cavity 33 and connected to the recharged plug 331.

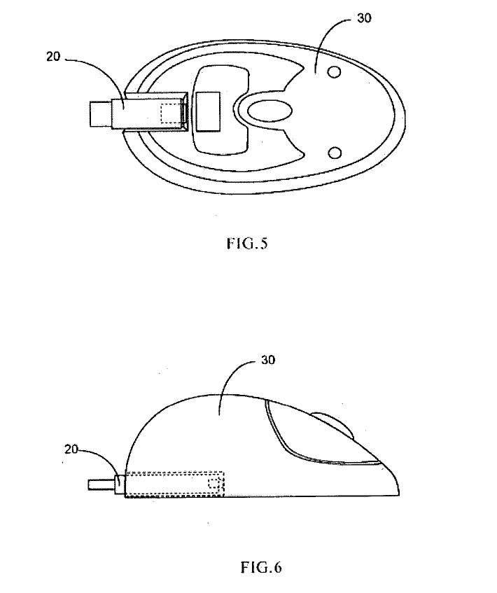

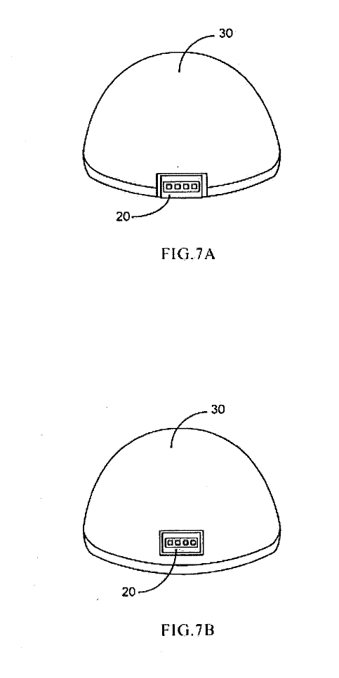

FIG. 6 is a lateral view of the present invention and FIG. 7 is a back view of the present invention. The receiver cavity 33 can be designed to any position of the input device 30.

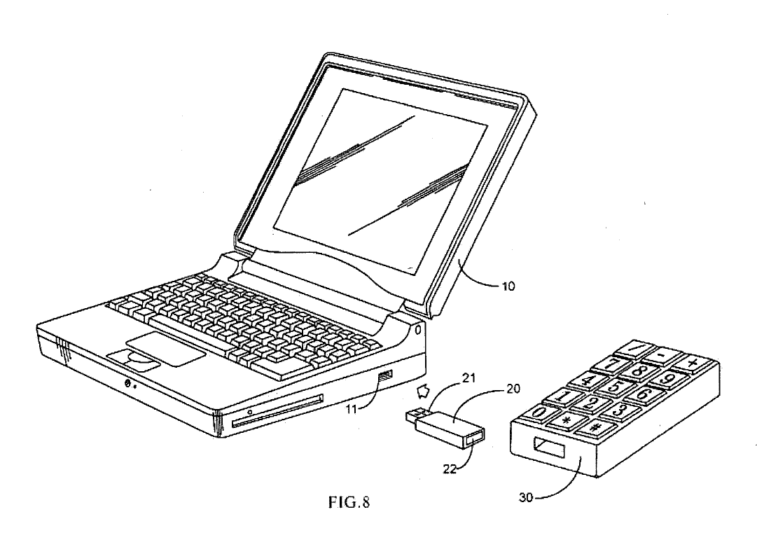

FIG. 8 is a structure drawing of the second embodiment of the present invention. The wireless input device 30 can be the group consisting of a mouse, a keyboard, a track ball, a hand writing plate, numeric keypad, earphone and a touch pad.

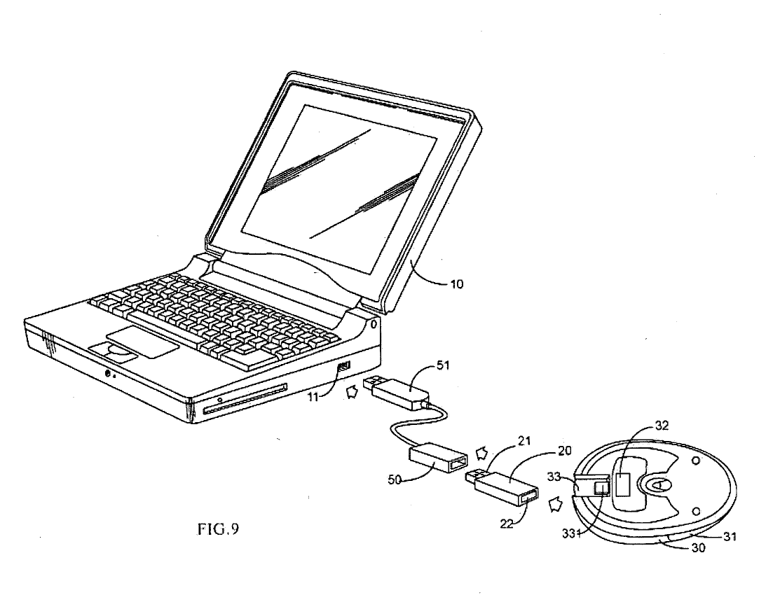

FIG. 9 is a structure drawing of the third embodiment of the present invention. It comprises an extended cable with a mother-connector 50 and a father-connector 51. When using the wireless input device 30 to control the computer 10 with a run out battery, people can connect the receiver 20 to an extended father-connector 51 and connect the mother-connector 50 to the connector socket 11 of the computer 10. By this way, people can control the computer and charge the wireless input device 30 at the same time.

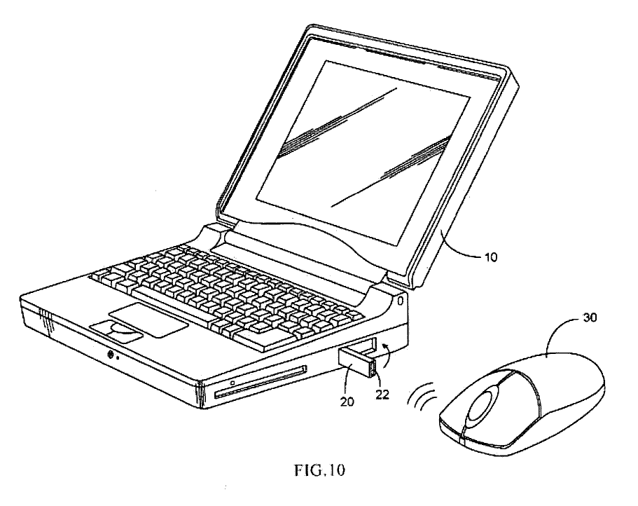

FIG. 10 is a structure drawing of the forth embodiment of the present invention. The receiver 20 can be equipped inside the computer 10. The receiver 20 can be expand when it is used.

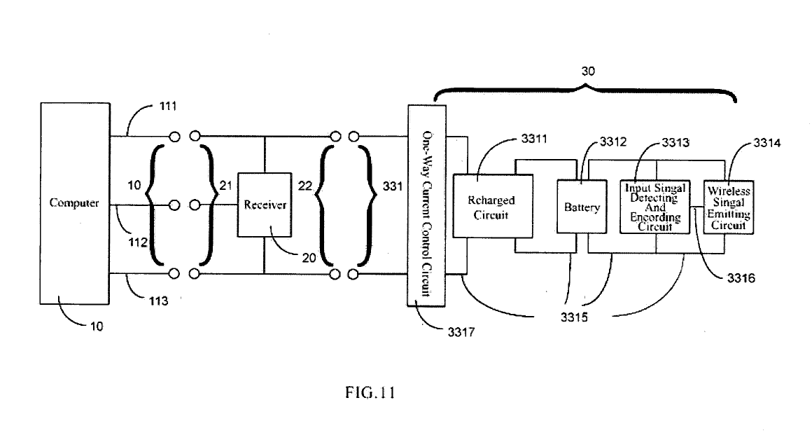

FIG. 11 is a circuit diagram of the present invention. The computer 10 comprises a positive power line 111, input signal line 112, and negative power line 113. All of the lines mentioned above are connected to the receiver 220. The receiver 20 comprises connector 21 and a recharged socket 22. The recharged socket 22 is connected to the wireless input device 30. The wireless input device comprises a recharged plug 331, a recharged circuit 3311, a battery 3312, an input signal detecting and encoding circuit 3313, a wireless signal emitting circuit 3314, a power line and circuit line 3315, a signal line 3316, one-way current control circuit 3317.

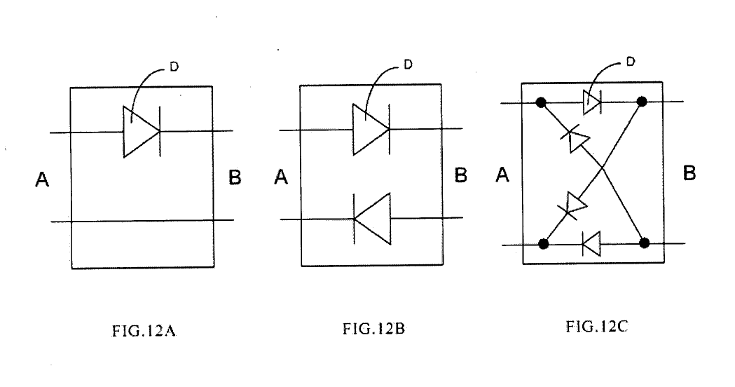

FIG. 12 is a circuit diagram of one-way current control circuit in the present invention. A-side is for the computer 10 and B-side is for the wireless input device 20. Because of the existence of the diode D, the current only flow through A-side to B-side.

While the present invention has been described with reference to the illustrative embodiment, this description is not intended to be construed in a limited sense. Various modifications of the illustrative embodiment of the invention such as the kind of the input device and the position of the receiver slot will be apparent to those skilled in the art with reference to this description. It is therefore completed that the appended claims will cover any such modifications or embodiments as fall within the true scope of the invention.

What is claimed is:

1. A wireless input device charged through an attachable receiver, comprising:
a wireless input device operated by users for controlling a computer, said input device has a cavity, said cavity has a recharged plug for being recharged; and
a receiver connected to said computer receiving the data from said input device and transmitting it to a computer, said receiver has a recharged socket for transporting power through said recharged plug to said wireless input device.

2. A wireless input device charged through an attachable receiver according to claim 1 wherein said wireless input device can be equipped with a laser emitting device.

3. A wireless input device charged through an attachable receiver according to claim 1 wherein said wireless input device transmitting the data by infra-ray or electromagnetic wave.

4. A wireless input device charged through an attachable receiver according to claim 1 wherein said wireless input device can be the group consisting of a mouse, a keyboard, a track ball, a hand writing plate, numeric keypad, earphone and a touch pad.

5. A wireless input device charged through an attachable receiver according to claim 2 wherein said wireless input device can be the group consisting of a mouse, a keyboard, a track ball, a hand writing plate, and a touch pad.

6. A wireless input device charged through an attachable receiver according to claim 3 wherein said wireless input device can be the group consisting of a mouse, a keyboard, a track ball, a hand writing plate, and a touch pad.

7. A wireless input device charged through an attachable receiver according to claim 1 wherein said receiver can be connected to said computer by an extended cable.

8. A wireless input device charged through an attachable receiver according to claim 1 wherein said receiver can be built in said computer.

9. A wireless input device charged through an attachable receiver according to claim 1 wherein said computer can be other electronic equipment.

10. A wireless input device charged through an attachable receiver according to claim 3 wherein said computer can be other electronic equipment.

11. A wireless input device charged through an attachable receiver according to claim 7 wherein said computer can be other electronic equipment.

12. A wireless input device charged through an attachable receiver according to claim 8 wherein said computer can be other electronic equipment.

13. A wireless input device charged through an attachable receiver according to claim 1 wherein said recharged plug can be replaced by a recharged socket and said socket can replaced by a recharged plug at the same time.
